(19) United States
(12) Patent Application Publication
(10) Pub. No.: US 2025/0157142 A1
(43) Pub. Date: May 15, 2025

(54) DEVICES, SYSTEMS, AND METHODS FOR GENERATING THREE-DIMENSIONAL AVATARS OF USERS

(71) Applicant: ATI Technologies ULC, Markham (CA)

(72) Inventors: Imran Nazir Junejo, Markham (CA); Akash Haridas, Markham (CA)

(73) Assignee: ATI Technologies ULC, Markham (CA)

(21) Appl. No.: 18/509,218

(22) Filed: Nov. 14, 2023

(51) Int. Cl. G06T 17/00; G06T 3/00; G06T 11/00; G06T 13/40; G06V 10/141; G06V 40/16

(52) U.S. Cl. CPC G06T 17/00; G06T 3/067; G06T 11/001; G06T 13/40; G06V 10/141; G06V 40/171

(57) ABSTRACT

A computing device can include circuitry configured to generate a set of two-dimensional textures based at least in part on a set of images that depict a head of a user. The circuitry can be further configured to generate a three-dimensional avatar that depicts the head of the user with substantially even illumination by applying a blend of the set of two-dimensional textures to a head model. The computing device can also include an output device configured to facilitate presentation of the three-dimensional avatar of the user. Various other devices, systems, and methods are also disclosed.

### BACKGROUND

Certain software applications, such as teleconferencing and/or virtual-reality (VR) applications, implement avatars that represent users. For example, a cloud-based solution can generate an animatable avatar that represents a user from one or more images of the user. In another example, a teleconferencing application can apply and/or implement a selectable or configurable avatar that represents a user without relying on any images of the user. These avatars can serve and/or function to protect the privacy of the user and/or conserve bandwidth in connection with the corresponding software applications.

### BRIEF DESCRIPTION OF THE DRAWINGS

The accompanying drawings illustrate a number of exemplary implementations and are a part of the specification. Together with the following description, these drawings demonstrate and explain various principles of the instant disclosure.

FIG. 1 is an illustration of an exemplary computing device for generating three-dimensional (3D) avatars of users according to one or more implementations of this disclosure.

FIG. 2 is an illustration of exemplary circuitry that facilitates and/or supports generating 3D avatars of users according to one or more implementations of this disclosure.

FIG. 3 is an illustration of exemplary images used to generate 3D avatars of users according to one or more implementations of this disclosure.

FIG. 4 is an illustration of exemplary textures derived and/or extracted from images used to generate 3D avatars according to one or more implementations of this disclosure.

FIG. 5 is an illustration of an exemplary template map with which portions of textures are blended to generate a 3D avatar according to one or more implementations of this disclosure.

FIG. 6 is an illustration of an exemplary pipeline that facilitates and/or supports generating 3D avatars of users according to one or more implementations of this disclosure.

FIG. 7 is an illustration of an exemplary mask operation that involves generating a final mask for defining which portions of textures are blended to form a 3D avatar according to one or more implementations of this disclosure.

FIG. 8 is an illustration of an exemplary blend operation that involves generating a blended texture via Laplacian pyramids according to one or more implementations of this disclosure.

FIG. 9 is an illustration of an exemplary wrap operation that involves applying blended textures to a head model for generating a 3D avatar according to one or more implementations of this disclosure.

FIG. 10 is a flowchart of an exemplary method for generating 3D avatars of users according to one or more implementations of this disclosure.

Throughout the drawings, identical reference characters and descriptions indicate similar, but not necessarily identical, elements. While the exemplary implementations described herein are susceptible to various modifications and alternative forms, specific implementations have been shown by way of example in the drawings and will be described in detail herein. However, the exemplary implementations described herein are not intended to be limited to the particular forms disclosed. Rather, the instant disclosure covers all modifications, equivalents, and alternatives falling within the scope of the appended claims.

### DETAILED DESCRIPTION OF EXEMPLARY IMPLEMENTATIONS

The present disclosure describes various devices, systems, and methods for generating 3D avatars of users. In some examples, a computing device can include and/or represent an end-to-end pipeline that generates animatable 3D avatars of users from images of the users. For example, a laptop can include and/or incorporate a webcam that captures low-quality photographs and/or videos of a user. In one example, the photographs and/or videos can include and/or represent image frames that show the user at different viewing angles. In this example, the image frames can include and/or represent an uneven and/or inconsistent distribution of illumination (due, e.g., to sunlight, artificial light, flash, and/or glare) across the user's face.

Unfortunately, in certain examples, the presence of uneven and/or inconsistent illumination in the image frames can lead to and/or result in a similarly uneven and/or inconsistent distribution of illumination in an avatar generated from those image frames. In one example, to avoid such uneven illumination, an end-to-end pipeline included in the laptop's circuitry can unwrap a set of images that depict the user's head from different viewing angles into a set of two-dimensional (2D) textures. In this example, the end-to-end pipeline can generate a 3D avatar that depicts the head of the user with substantially even illumination by applying a blend of the 2D textures to a head model and/or mesh.

In some examples, the end-to-end pipeline can sequentially blend the 2D textures with one another to generate a user-specific texture map. In one example, the end-to-end pipeline can implement Laplacian pyramids to blend the user-specific texture map with a generic texture map. By doing so, the end-to-end pipeline is able to mitigate, eliminate, and/or remove the directional illumination from the user-specific texture map, thereby rendering a final texture map for wrapping onto and/or around the head model and/or mesh to generate an evenly illuminated, animatable 3D avatar of the user.

Accordingly, the end-to-end pipeline can enable the computing device to generate the evenly illuminated 3D avatar of the user from low-quality webcam images even though the webcam images include and/or show directional illumination on the user's face. Additionally or alternatively, the end-to-end pipeline can enable the computing device to generate the evenly illuminated 3D avatar of the user on its own without offloading the corresponding compute to other devices and/or the cloud.

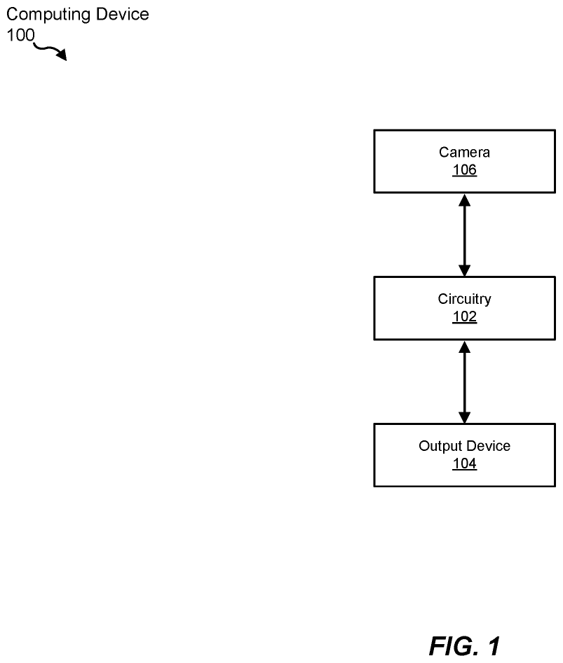

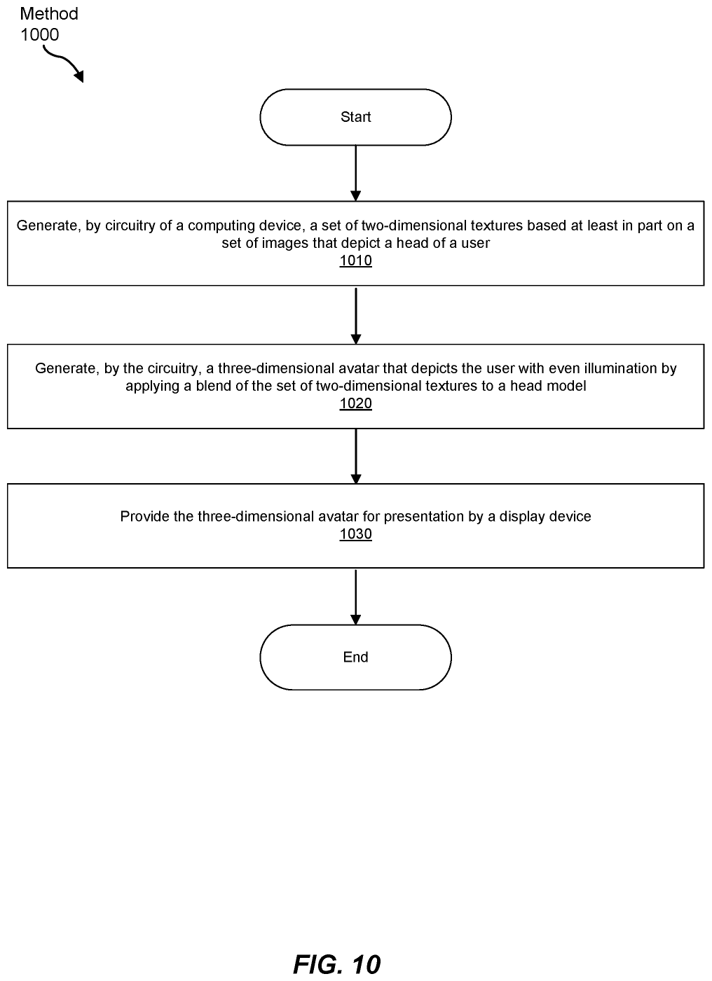

The following will provide, with reference to FIGS. 1-9, detailed descriptions of exemplary devices, systems, and/or corresponding implementations for generating 3D avatars of users. In addition, detailed descriptions of an exemplary method for generating 3D avatars of users will be provided in connection with FIG. 10.

FIG. 1 illustrates an exemplary computing device 100 that facilitates and/or supports generating 3D avatars of users. As illustrated in FIG. 1, exemplary computing device 100 can include and/or represent circuitry 102, an output device 104, and/or a camera 106. In some examples, circuitry 102 can be electrically and/or communicatively coupled to output device 104 and/or camera 106. In one example, circuitry 102 can be configured, arranged, and/or designed to generate 3D avatars of users from images captured by camera 106. Additionally or alternatively, circuitry 102 and/or another processing device can provide, output, and/or deliver such 3D avatars to output device 104 for display to the user and/or for transmission to a remote computing device.

In some examples, circuitry 102 can include and/or represent a plurality of electrical components, such as transistors, resistors, capacitors, diodes, multiplexers, inductors, switches, registers, flipflops, connections, traces, buses, semiconductor devices, processing devices, and/or storage devices. In one example, circuitry 102 can include and/or represent one or more circuits that facilitate and/or support generating animatable 3D avatars. For example, circuitry 102 can include and/or represent an end-to-end pipeline consisting of and/or equipped with multiple data processing elements configured to collectively perform the various steps and/or processes necessary to generate animatable 3D avatars. In certain implementations, circuitry 102 can include and/or represent a hardware accelerator and/or a special-purpose hardware device designed to generate animatable 3D avatars. Examples of circuitry 102 include, without limitation, system on chips (SoCs), application-specific integrated circuits (ASICs), physical processors, central processing units (CPUs), microprocessors, microcontrollers, parallel accelerated processors, tensor cores, integrated circuits, chiplets, portions of one or more of the same, variations or combinations of one or more of the same, and/or any other suitable circuitry.

In some examples, output device 104 can be configured and/or programmed to facilitate and/or support the presentation and/or transmission of 3D avatars. In one example, output device 104 can include and/or represent a processing device responsible for providing 3D avatars for presentation to the users on a display. In another example, output device 104 can include and/or represent a display and/or monitor on which 3D avatars are presented to the users. Additionally or alternatively, output device 104 can include and/or represent a transmitter and/or transceiver that transmits data representative of 3D avatars to remote devices (e.g., in connection with a teleconferencing and/or VR application).

In some examples, circuitry 102 can be configured and/or programmed to generate a set of 2D textures based at least in part on a set of images. In other words, circuitry 102 can be configured and/or programmed to unwrap a set of images that depict the head and/or face of a user into a set of 2D textures. For example, circuitry 102 can generate data that constitutes graphical depictions of the head and/or face of the user in flattened configuration based at least in part on the set of images. In this example, the graphical depictions of the user's head and/or face can be captured and/or recorded to fit across a set of segmentation masks. In one example, the segmentation masks can be derived and/or obtained from the set of images by applying a predefined and/or off-the-shelf face segmentation neural network. The resulting data can constitute and/or represent a set of 2D textures that are used to generate a 3D avatar of the user.

In some examples, computing device 100 can generally represent any type or form of physical computing device capable of reading computer-executable instructions. In one example, computing device 100 can include and/or be communicatively coupled to a display and/or monitor. In this example, computing device 100 can display and/or present 3D avatars for viewing by a local user. Additionally or alternatively, computing device can transmit and/or provide 3D avatars to a remote computer for viewing by a remote user. Examples of computing device 100 include, without limitation, laptops, tablets, desktops, servers, cellular phones, smart phones, client devices, Personal Digital Assistants (PDAs), multimedia players, embedded systems, wearable devices, gaming consoles, displays, monitors, variations or combinations of one or more of the same, and/or any other suitable computing devices.

In some examples, circuitry 102 and/or another processing device can select and/or choose the set of images to be used in generating the 3D avatar of the user. In such examples, circuitry 102 and/or the other processing device can make this selection of images based at least in part on certain criteria (e.g., the quality of the images, the viewing angle of the user's head and/or face depicted in the images, the user's position in the images, the clarity of the images, the blurriness of the images, etc.). In one example, the set of images can include and/or represent photographs and/or image frames from a video. Additionally or alternatively, the set of images can include and/or show directional illumination (e.g., lighting, flash, glare, etc.) on and/or across the user's head and/or face.

In some examples, the 2D textures can appear as pictures of the user's features smashed, disposed, and/or unwrapped across a flat surface. In such examples, the 2D textures can include and/or represent UV maps. In one example, the UV maps can constitute and/or represent translations and/or conversions of the 3D objects in the set of images to 2D representations. For example, in the 2D textures, the user's facial features can appear stretched and/or flattened across a 2D plane rather than being wrapped around and/or onto the user's head in a 3D space. In this example, the 2D textures can be processed and/or blended before being applied to a head model and/or mesh to generate a 3D avatar of the user.

In some examples, circuitry 102 can be configured and/or programmed to generate and/or create a 3D avatar that depicts the head of the user with substantially even illumination. For example, circuitry 102 can blend the 2D textures to one another and/or with a neutral template map. In this example, circuitry 102 can apply and/or wrap the blended 2D textures to a head model and/or mesh that represents the user's head and/or face. By doing so, circuitry 102 can generate and/or create a 3D avatar of the user with a substantially even and/or uniform distribution of illumination on and/or across the user's head and/or face.

In some examples, substantially even illumination can refer to and/or represent the amount of lighting and/or illumination portrayed or depicted on the head of the user in the 3D avatar as being relatively consistent (within a certain degree of variance), even, and/or smooth. For example, the 3D avatar can include and/or show an amount of lighting and/or illumination that is identical, uniform, and/or symmetrical across certain areas and/or facial features. Additionally or alternatively, the 3D avatar can include and/or show an amount of lighting and/or illumination whose consistency, evenness, and/or smoothness across certain areas and/or facial features is within an acceptable degree of variation, difference, and/or tolerance. In other words, the amount of lighting and/or illumination included and/or shown in certain areas and/or facial features of the 3D avatar can exhibit variation, difference, and/or tolerance so long as such variation, difference, and/or tolerance satisfies a certain threshold of consistency, evenness, and/or smoothness. In certain implementations, the 3D avatar may depict the head of the user with substantially even illumination by including and/or showing no more than 50%, 40%, 30%, 20%, 10%, 5%, and/or 1% variation in illumination, brightness, and/or luminosity among the pixels used to represent one or more portions of the user's head.

In some examples, substantially even illumination can refer to and/or represent the amount of lighting and/or illumination portrayed or depicted in one area of the 3D avatar as matching and/or coinciding with the amount of lighting and/or illumination portrayed or depicted in another area of the 3D avatar. In one example, the 3D avatar can include and/or show an axis of symmetry of the user's face (e.g., a vertical axis that runs vertically down the center of the user's face, etc.). In this example, the 3D avatar can exhibit and/or demonstrate substantially even illumination by showing the amount of apparent lighting across the axis of symmetry as having and/or maintaining a certain threshold of consistency, evenness, and/or smoothness.

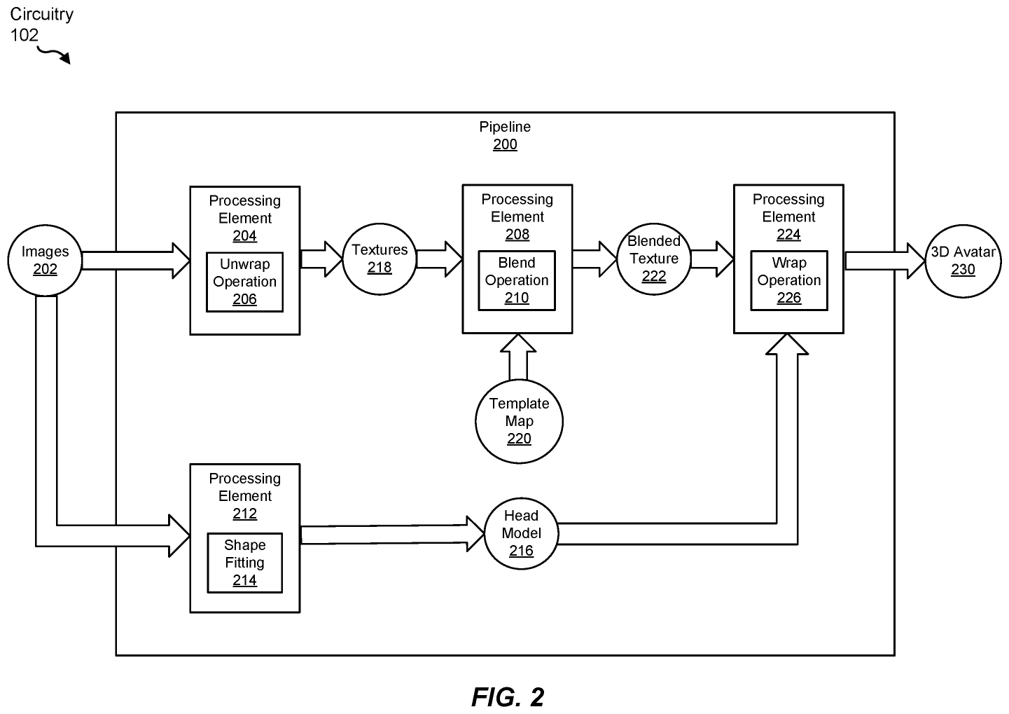

FIG. 2 illustrates an exemplary implementation of circuitry 102 that facilitates and/or supports generating 3D avatars of users. In some examples, circuitry 102 can include and/or represent certain components and/or features that perform and/or provide functionalities that are similar and/or identical to those described above in connection with FIG. 1. As illustrated in FIG. 2, circuitry 102 can include and/or represent a pipeline 200 consisting of and/or equipped with processing elements 204, 208, 212, and 224. In one example, pipeline 200 can receive and/or obtain images 202 of a user from camera 106. In this example, pipeline 200 can generate and/or output a 3D avatar 230 of the user from and/or based on images 202.

In some examples, 3D avatar 230 can include and/or contain 3D representations and/or depictions of the head and/or face of the user as applied to and/or wrapped around a head model 216. In such examples, 3D avatar 230 can include and/or represent a substantially even and/or uniform distribution of illumination on and/or across the user's head and/or face despite being derived and/or developed from images 202, which include and/or represent a substantially uneven and/or nonuniform distribution of illumination on and/or across the user's head and/or face.

In some examples, upon arriving at and/or reaching pipeline 200, images 202 can be fed and/or delivered to processing elements 204 and 212. In one example, processing element 204 can be configured and/or programmed to unwrap images 202 to textures 218. For example, processing element 204 can perform an unwrap operation 206, which translates and/or converts images 202 to textures 218. In this example, images 202 can include and/or contain representations and/or depictions of the head and/or face of the user, and textures 218 can include and/or contain 2D representations and/or depictions of the head and/or face of the user.

In one example, processing element 212 can be configured and/or programmed to shape, size, and/or contour a head model 216 on which a subsequently blended combination of textures 218 will eventually be applied and/or disposed. For example, processing element 212 can perform shape fitting 214 on an initial estimate of head model 216. As part of shape fitting 214, processing element 212 can identify and/or render an estimate of head model 216 based at least in part on one or more input parameters. In this example, processing element 212 can compare the estimate of head model 216 to one or more of images 202. Additionally or alternatively, processing element 212 can update the estimate of head model 216 by modifying the one or more input parameters based at least in part on a result of the comparison.

In some examples, processing element 212 can compare the updated estimate of head model 216 to one or more of images 202 according to one or more loss functions. In one example, the loss function(s) can measure, gauge, and/or identify photometric loss (e.g., L1 loss), Huber loss, adversarial loss (e.g., generative adversarial loss), landmark loss, identity loss (e.g., using a facial recognition model), and/or perceptual loss. In this example, processing element 212 can refine the updated estimate of head model 216 by modifying the one or more input parameters based at least in part on the output and/or result rendered by the loss function. For example, processing element 212 can update the input parameters by backpropagating the loss rendered by the loss function and then using gradient descent.

In some examples, this process of refining head model 216 can continue and/or last over various iterations (e.g., a hundred iterations, a thousand iterations, ten thousand iterations, etc.). For example, processing element 212 can iteratively compare the estimate of head model 216 to one or more of images 202 until the output and/or result of the loss function satisfies a certain threshold. In this example, the satisfaction of that threshold can indicate and/or suggest that head model 216 has been refined and/or modified to the point of accurately representing and/or resembling the shape of the user's head and/or face as depicted in one or more of images 202.

In some examples, the refined head and/or face shape can accurately reflect and/or resemble the shape, size, and/or position of various facial features of the user as depicted in one or more of images 202. Examples of such facial features include, without limitation, eyes, ears, noses, mouths, lips, eyebrows, foreheads, hair, hairlines, cheeks, chins, jaws, jawlines, necks, wrinkles, blemishes, scars, skin, skin textures, skin colors, combinations or variations of one or more of the same, and/or any other suitable facial features.

In some examples, processing element 212 can compare facial features represented in head model 216 to facial features identified in images 202. In this example, processing element 212 can modify and/or change the facial features represented in head model 216 based at least in part on the output and/or result of the comparison. For example, processing element 212 can backpropagate the output and/or result of the comparison to update the input parameters of head model 216 for the next iteration of the process. In this example, the updating of the input parameters can cause the facial features represented in head model 216 to be modified and/or changed in the next iteration of the process. In certain implementations, shape fitting 214 can terminate and/or end once the parameters of head model 216 converge and/or align with those of images 202.

In some examples, shape fitting 214 can operate and/or run on a single image frame at a time. However, to ensure that head model 216 is informed by different viewing angles of the user, processing element 212 and/or another processing element (not necessarily illustrated in FIG. 2) can refine head model 216 by jointly optimizing the shape of head model 216 over all of images 202. In one example, processing element 212 and/or the other processing element can estimate N sets of pose and/or illumination parameters but only 1 set of shape parameters shared among all of images 202. In this example, processing element 212 and/or the other processing element can average the loss function over all of images 202 to optimize the parameters. By doing so, processing element 212 and/or the other processing element can shape, refine, and/or otherwise process head model 216 from multiple viewing angles.

In some examples, processing element 208 can be configured and/or programmed to blend textures 218 with one another and/or with a template map 220 depicting evenly distributed illumination. For example, processing element 208 can perform a blend operation 210 on textures 218 and/or template map 220. In one example, blend operation 210 can involve sequentially blending all or portions of textures 218 with one another. In certain implementations, the portions of textures 218 to be blended can be defined and/or identified by certain masks (such as segmentation and/or visibility masks).

In some examples, the sequential blending can involve combining two of textures 218 at the outset and then combining the result with another one of textures 218. Such sequential blending can continue in this way until all of textures 218 have been incorporated into and/or accounted for in the combination and/or result. In one example, blend operation 210 can also involve combining the result of sequentially blending textures 218 with template map 220. For example, processing element 208 can blend the combination of textures 218 with template map 220 using Laplacian pyramids (e.g., one Laplacian pyramid for the combination of textures 218 and another Laplacian pyramid for template map 220). In this example, template map 220 can include and/or represent a generic, neutral texture base.

In some examples, processing element 208 can generate and/or create Laplacian pyramids based at least in part on images 202. In one example, a Laplacian pyramid can constitute and/or represent a set of bandpass filtered images that are used to extract high spatial frequencies from images 202, which is where many of the user's facial features are encoded and/or recorded. In this example, each image in the set of bandpass filtered images can be spaced an octave apart and/or away from the next and/or adjacent image. For example, processing element 208 can construct and/or build a Gaussian pyramid that follows this formula: G(I)=[I₀, I₁, . . . , I_{K}], where I₀=I and I_{K}=K. In this example, K can constitute and/or represent the number of levels in the pyramid. In certain implementations, processing element 208 can develop a corresponding a Laplacian pyramid L(I) and/or its coefficients by taking a differential between the adjacent levels in the Gaussian pyramid G(I) and then upsampling the smaller level so that their sizes are compatible.

In some examples, the Gaussian pyramid can include and/or represent a bandpass pyramid of images at various levels of resolution. In one example, the Gaussian pyramid can be configured and/or arranged to form and/or take differences between the images at adjacent levels and/or to perform image interpolation between adjacent levels of resolution. In this example, the Gaussian pyramid can facilitate and/or support the computation of pixelwise differences among the images.

In some examples, subsequent images in the Gaussian pyramid can be weighted and/or scaled down via Gaussian averages and/or blurs. In such examples, certain pixels of the images can include and/or represent a local average that corresponds to a neighborhood pixel in a lower level of the Gaussian pyramid. In one example, a corresponding Laplacian pyramid can be similar to the Gaussian pyramid but include and/or maintain the difference image of blurred versions between the levels. In this example, the difference images can facilitate and/or support reconstruction of high resolution images using image compression.

In some examples, processing element 208 can implement and/or apply Laplacian pyramid L(I) to replace the high-frequency content of template map 220 with the high-frequency content from images 202. By doing so, processing element 208 can effectively extract and/or derive the high frequencies from the facial features depicted in the combination of textures 218 and then blend those high-frequency facial features with the low frequencies of template map 220. As a result, processing element 208 can blend the combination of textures 218 with template map 220 to generate and/or form 3D avatar 230.

In some examples, the Laplacian pyramid of a texture can include and/or represent multiple levels containing a different band of spatial frequencies ranging from low to high. In one example, processing element 208 can replace the high-frequency levels in the Laplacian pyramid of template map 220 with the high-frequency levels in the Laplacian pyramid of textures 218 to produce a new Laplacian pyramid. In this example, processing element 208 can reconstruct, restore, and/or invert this new Laplacian pyramid back to a new texture (e.g., blended texture 222) by performing the inverse of the operations used to construct and/or build such a pyramid. This new texture can include and/or represent the high-frequency details corresponding to the user's facial features (such as eyebrows, wrinkles, etc.) from textures 218, thus resembling the user represented in the images but also having even illumination like template map 220.

In some examples, processing element 208 can refine the combination of textures 218 before or after being blended with template map 220. For example, processing element 208 and/or another processing element can implement and/or apply a neural network architecture (such as a U-Net, an artificial neural network, a convolutional neural network, etc.) to refine the combination of textures 218. By doing so, processing element 208 can effectively restore and/or reverse the degradation caused by camera 106 (e.g., a low-quality webcam).

In certain examples, computing device 100, circuitry 102, and/or processing element 208 can train the neural network architecture to refine the combination of textures 218 with a set of training data. In one example, such training can enable the neural network architecture to restore and/or reverse simulated laptop webcam degradation by enhancing and/or refining the combination of textures 218. Additionally or alternatively, processing element 208 can perform the refinement of the combination of textures 218 in UV space. By doing so in UV space, processing element 208 can maintain and/or retain the integrity of the shapes and/or facial features depicted and/or represented in the combination of textures 218.

In some examples, processing element 208 can derive, develop, and/or produce a blended texture 222 upon completion of blend operation 210 and/or any additional refinements. In one example, blended texture 222 can constitute and/or represent the final UV and/or texture map, which is ready to be applied to and/or wrapped over head model 216. Additionally or alternatively, blended texture 222 can include and/or represent a high-fidelity texture map with evenly distributed illumination across the user's head and/or face despite being generated and/or produced from low-quality webcam images with unevenly distributed illumination across the user's head and/or face.

In some examples, processing element 224 can receive and/or obtain blended texture 222 from processing element 208. In such examples, processing element 224 can also receive and/or obtain head model 216 from processing element 224. Upon receiving and/or obtaining blended texture 222 and head model 216, processing element 224 can perform a wrap operation 226 in which blended texture 222 are applied to head model 216. For example, processing element 224 can wrap and/or stretch blended texture 222 on, over, and/or around head model 216 to generate and/or produce 3D avatar 230 of the user. Accordingly, wrap operation 226 can transform and/or convert blended texture 222 into a 3D representation and/or image whose shape, size, and/or contours are defined or informed by head model 216.

In some examples, although FIG. 2 illustrates pipeline 200 as including and/or representing only processing elements 204, 208, 212, and 224, pipeline 200 can alternatively include and/or represent various other data processing elements that facilitate and/or support generating 3D avatars of users. In one example, some of the operations and/or processes described herein can be performed by one of processing elements 204, 208, 212, and 224, while other operations and/or processes described herein can actually be performed by other processing elements that are not necessarily illustrated and/or labelled in FIG. 2. For example, shape fitting 214 and the multi-view refinement of head model 216 can be performed by separate and/or distinct processing elements included in pipeline 200. In another example, blend operation 210 and the refinement of degradation in textures 218 can be performed by separate and/or distinct processing elements included in pipeline 200. Additionally or alternatively, some of processing elements 204, 208, 212, and 224 can be consolidated and/or combined in pipeline 200 to perform certain operations and/or processes described in connection with other processing elements.

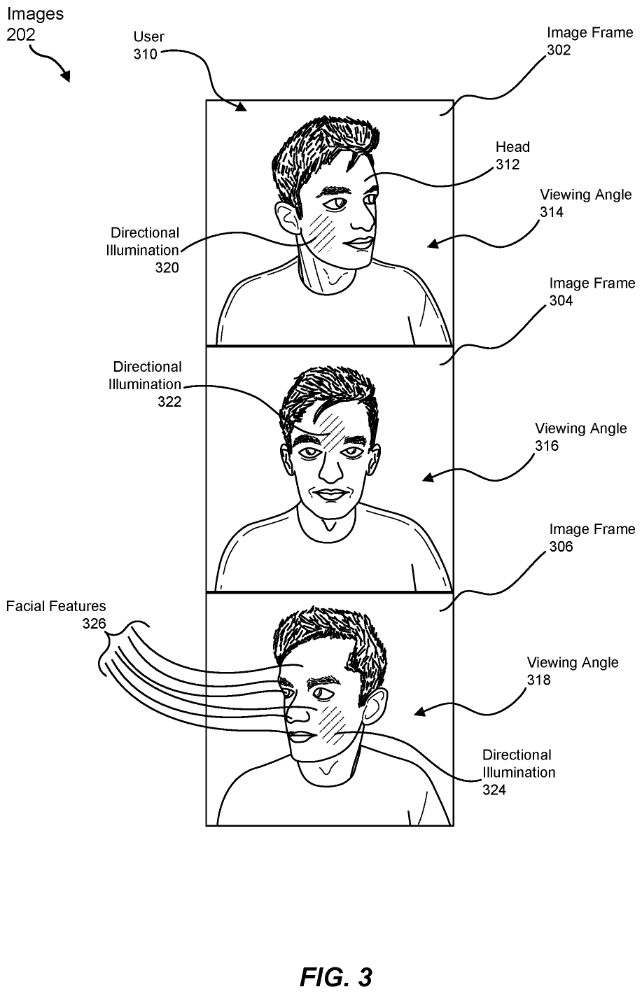

FIG. 3 illustrates an exemplary set of images 202 captured by camera 106 of computing device 100. In some examples, images 202 in FIG. 3 can include and/or represent graphics and/or features that serve certain purposes similar and/or identical to those described above in connection with either FIG. 1 or FIG. 2. As illustrated in FIG. 3, images 202 can include and/or represent image frames 302, 304, and 306 of a user 310. In one example, images 202 can capture and/or represent photographs and/or frames taken of user 310 at different viewing angles (e.g., facing forward, facing to the right, and/or facing to the left). Additionally or alternatively, images 202 can include and/or show various facial features 326 of user 310 as well as directional illumination distributed across different portions of a head 312 of user 310.

As a specific example, image frame 302 can show and/or represent user 310 from a viewing angle 314. In this example, viewing angle 314 can show and/or represent user 310 looking and/or facing to the user's left. In addition, image frame 302 can include and/or show a directional illumination 320 on the right side of the user's face.

As another example, image frame 304 can show and/or represent user 310 from a viewing angle 316. In this example, viewing angle 316 can show and/or represent user 310 looking and/or facing forward and/or into camera 106. In addition, image frame 304 can include and/or show a directional illumination 322 on the center of the user's face and/or forehead.

As a further example, image frame 306 can show and/or represent user 310 from a viewing angle 318. In this example, viewing angle 318 can show and/or represent user 310 looking to the user's right. In addition, image frame 306 can include and/or show a directional illumination 324 on the left side of the user's face.

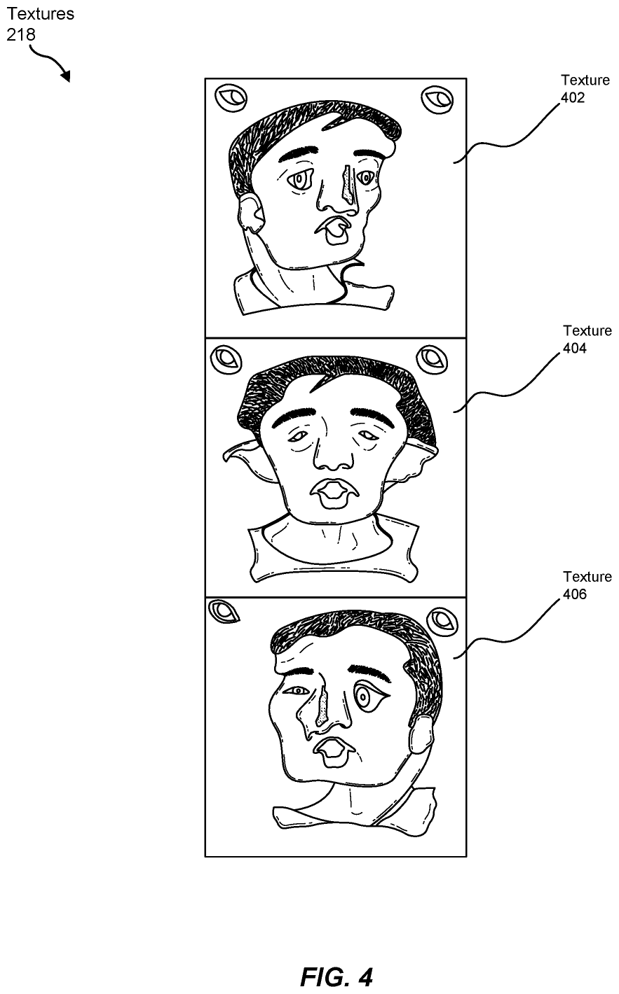

FIG. 4 illustrates an exemplary set of textures 218 that have been unwrapped and/or derived from images 202. In some examples, the set of textures 218 in FIG. 4 can include and/or represent graphics and/or features that serve certain purposes similar and/or identical to those described above in connection with any of FIGS. 1-3. As illustrated in FIG. 4, the set of textures 218 can include and/or represent flattened depictions and/or 3D-to-2D conversions of images 202. In one example, the set of textures 218 can include and/or represent a texture 402 derived from image frame 302, a texture 404 derived from image frame 304, and/or a texture 406 derived from image frame 306.

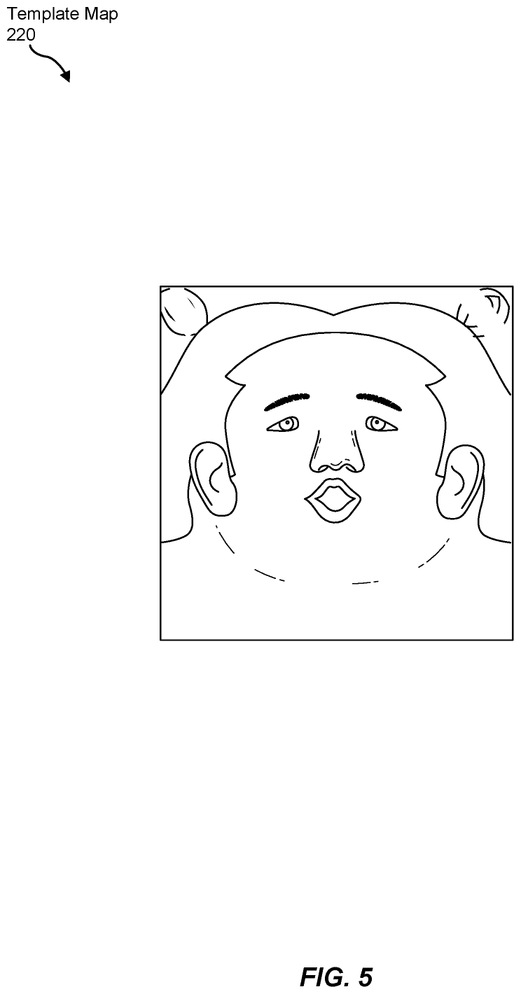

FIG. 5 illustrates an exemplary implementation of template map 220 whose high-frequency content is replaced by high-frequency content in textures 218 to generate and/or form blended texture 222. In some examples, template map 220 in FIG. 5 can include and/or represent graphics and/or features that serve certain purposes similar and/or identical to those described above in connection with any of FIGS. 1-4. As illustrated in FIG. 5, exemplary template map 220 can include and/or represent a generic, neutral texture base with which textures 218 are combined to generate blended texture 222. In one example, template map 220 can include and/or show an even distribution of illumination across a generic head and/or face.

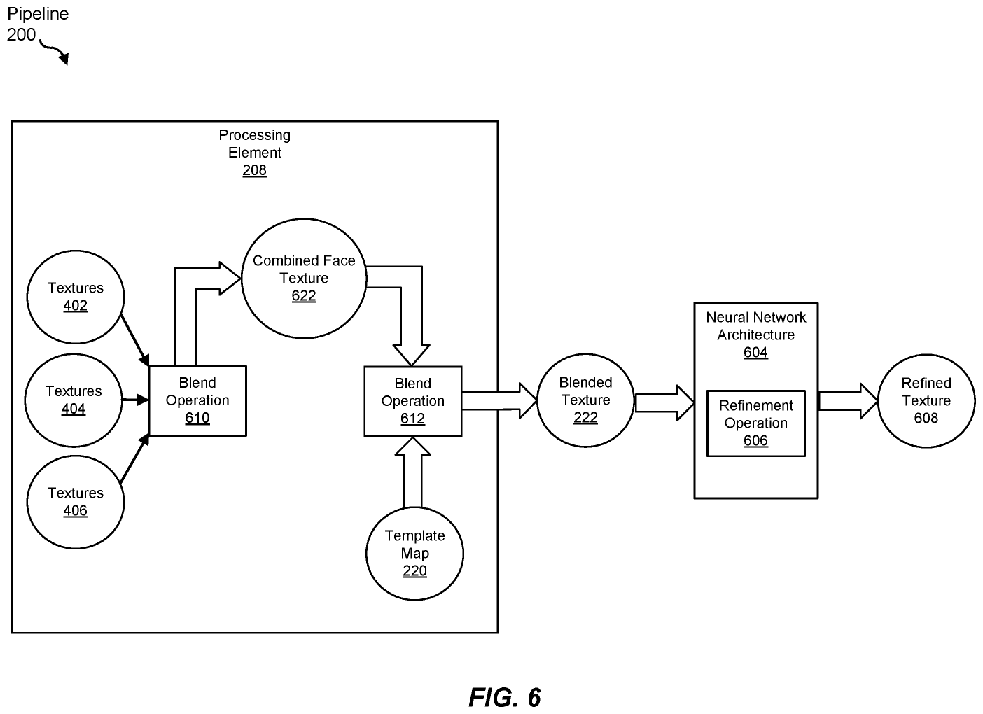

FIG. 6 illustrates an exemplary implementation of pipeline 200 that includes and/or represents processing element 208 and a neural network architecture 604. In some examples, pipeline 200 can include and/or represent certain components and/or features that perform and/or provide functionalities that are similar and/or identical to those described above in connection with any of FIGS. 1-5. As illustrated in FIG. 6, processing element 208 can perform a blend operation 610 on textures 402, 404, and 406 to blend them together. In one example, blend operation 610 can produce, render, and/or result in a combined face texture 622.

In some examples, processing element 208 can then perform a blend operation 612 on combined face texture 622 and template map 220 to blend them together using one or more Laplacian pyramids (e.g., one Laplacian pyramid for combined face texture 622 and another Laplacian pyramid for template map 220). In one example, blend operation 612 can produce, render, and/or result in blended texture 222. In this example, blended texture 222 can be passed, applied, and/or provided to neural network architecture 604 (such as a U-Net, an artificial neural network, a convolutional neural network, etc.).

In some examples, neural network architecture 604 can be implemented and/or executed by processing element 208. In other examples, neural network architecture 604 can be implemented and/or executed by another processing element that is not necessarily illustrated and/or labelled in FIG. 6.

In some examples, processing element 208 and/or the other processing element can implement and/or execute neural network architecture 604 to perform a refinement operation 606 on blended texture 222. In one example, through neural network architecture 604, processing element 208 and/or the other processing element can refine and/or enhance blended texture 222 to generate and/or form refined texture 608. In this example, processing element 208 and/or the other processing element can derive, develop, and/or produce refined texture 608 upon completion of refinement operation 606.

In one example, refined texture 608 can constitute and/or represent the final UV and/or texture map, which is ready to be applied to and/or wrapped over head model 216. Additionally or alternatively, refined texture 608 can include and/or represent a high-fidelity texture map with evenly distributed illumination across the user's head and/or face despite being generated and/or produced from low-quality webcam images with unevenly distributed illumination across the user's head and/or face.

In some examples, processing element 224 can receive and/or obtain refined texture 608 and/or head model 216. Upon receiving and/or obtaining refined texture 608 and head model 216, processing element 224 can perform wrap operation 226 to apply refined texture 608 to head model 216. For example, processing element 224 can wrap and/or stretch refined texture 608 on, over, and/or around head model 216 to generate and/or produce 3D avatar 230 of the user. Accordingly, wrap operation 226 can transform and/or convert refined texture 608 into a 3D representation and/or image whose shape and/or contours are defined or informed by head model 216.

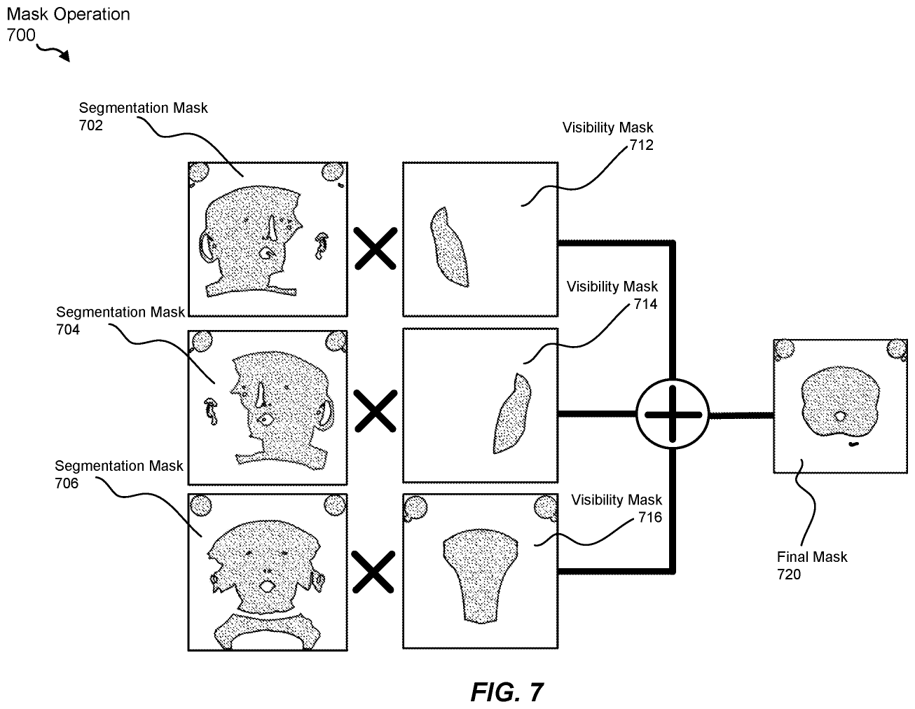

FIG. 7 illustrates an exemplary mask operation 700 defines and/or specifies which portions of textures 218 are blended with template map 220. In some examples, mask operation 700 can include and/or represent certain steps and/or features that serve purposes similar and/or identical to those described above in connection with any of FIGS. 1-6. As illustrated in FIG. 7, exemplary mask operation 700 can include and/or involve segmentation masks 702, 704, and 706 that define and/or represent areas of unwrapped textures 218 that are relevant and/or meaningful to blend operation 210. Additionally or alternatively, exemplary mask operation 700 can include and/or involve visibility masks 712, 714, and 716 that further define and/or represent areas of unwrapped textures 218 that are relevant and/or meaningful to blend operation 210.

In some examples, segmentation masks 702, 704, and 706 can be derived and/or obtained from images 202 by applying a face segmentation neural network. Additionally or alternatively, visibility masks 712, 714, and 716 can be developed and/or derived in pipeline 200.

In some examples, computing device 100 and/or circuitry 102 can combine segmentation masks 702, 704, and 706 with visibility masks 712, 714, and 716, respectively. For example, computing device 100 and/or circuitry 102 can render and/or produce a set of intermediate masks that define and/or represent areas common to segmentation masks 702 segmentation masks 702, 704, and 706 and visibility masks 712, 714, and 716, respectively. In one example, computing device 100 and/or circuitry 102 can add and/or sum all the intermediate masks together to produce and/or form a final mask 720. In this example, final mask 720 can define the areas and/or regions of the combination of textures 218 that are to replace the corresponding areas and/or regions of template map 220 in blend operation 210.

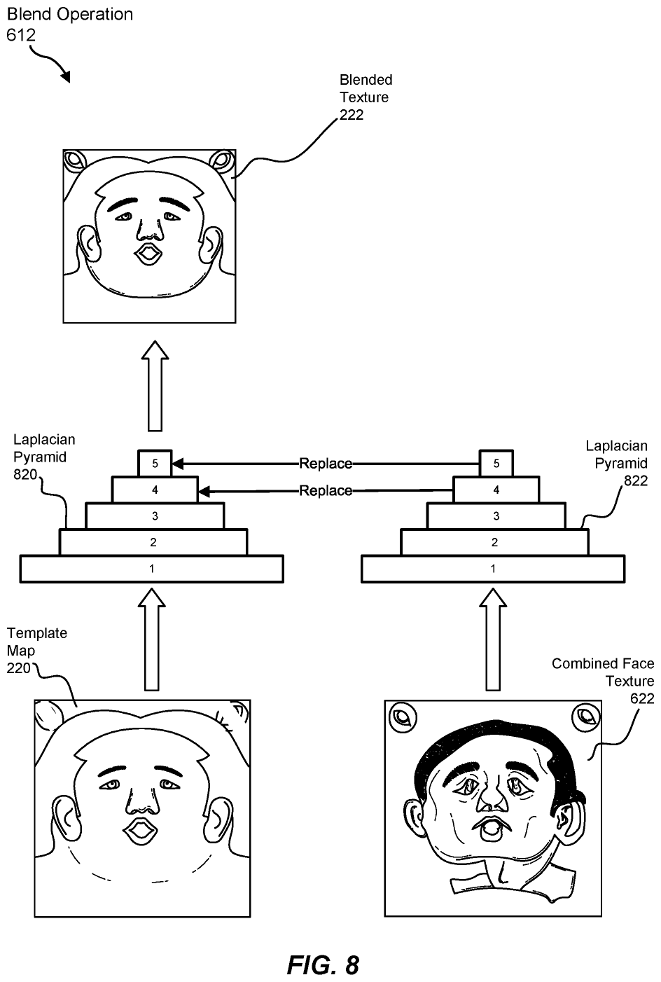

FIG. 8 illustrates an exemplary blend operation 612 in which template map 220 and combined face texture 622 are blended together to produce blended texture 222. In some examples, blend operation 612 can include and/or represent certain steps and/or features that serve purposes similar and/or identical to those described above in connection with any of FIGS. 1-7. As illustrated in FIG. 8, exemplary blend operation 612 can utilize and/or rely on Laplacian pyramids 820 and 822 to generate, produce, and/or render blended texture 222. For example, processing element 208 can obtain, construct, and/or build a Laplacian pyramid 822 based at least in part on combined face texture 622. Additionally or alternatively, processing element 208 can obtain, construct, and/or build a Laplacian pyramid 820 based at least in part on template map 220.

In some examples, Laplacian pyramids 820 and 822 can each include and/or represent five levels of resolution. In one example, level 1 of Laplacian pyramids 820 and 822 can include and/or represent the lowest level of resolution, and level 5 of Laplacian pyramids 820 and 822 can include and/or represent the highest level of resolution. In other words, level 1 of Laplacian pyramids 820 and 822 can include and/or represent lowest spatial frequency, and level 5 of Laplacian pyramids 820 and 822 can include and/or represent the highest spatial frequency.

In some examples, blend operation 612 can include and/or involve replacing the highest levels of resolution and/or spatial frequency in Laplacian pyramid 820 with a copy of the highest levels of resolution and/or spatial frequency in Laplacian pyramid 822. For example, blend operation 612 can include and/or involve replacing levels 4 and 5 of Laplacian pyramid 820 with those of Laplacian pyramid 822 while maintaining levels 1, 2, and 3 of Laplacian pyramid 820 intact. In one example, the result of this replacement can constitute and/or represent an output of blended texture 222 for blend operation 612.

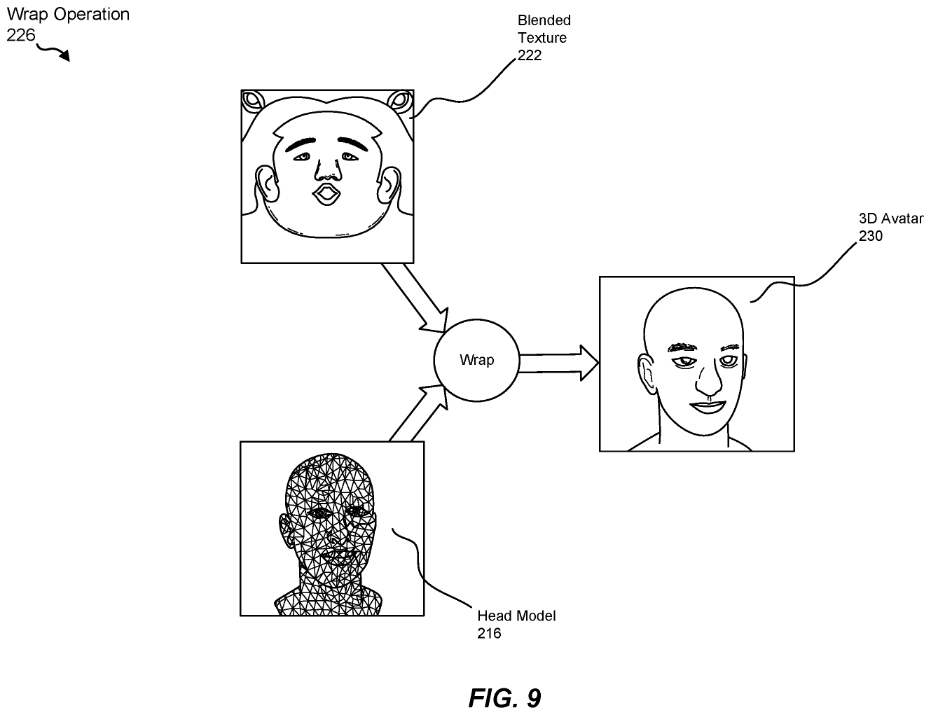

In some examples, processing element 208 can compute Gaussian pyramids (gₖ, gₖ₋₁ . . . g₁) for template map 220 and/or combined face texture 622 by repeatedly applying Gaussian blur and/or subsampling to template map 220 and/or combined face texture 622. For example, processing element 208 can compute Laplacian pyramids 820 and 822 (Lₖ=gₖ−UPSAMPLE (gₖ₋₁), Lₖ₋₁=gₖ₋₁−UPSAMPLE (gₖ₋₂) . . . L₁=g₁) from the Gaussian pyramids. In this example, processing element 208 can compute Laplacian pyramids 820 and 822 (Lₖ=gₖ−UPSAMPLE (gₖ₋₁), Lₖ₋₁=gₖ₋₁−UPSAMPLE (gₖ₋₂), L₁=g₁) from the Gaussian pyramids. In this example, processing element 208 can then reconstruct, restore, and/or invert the Laplacian pyramid formed by replacing the high-frequency content back to a new texture (e.g., blended texture 222) by performing the inverse of the operations used to construct and/or build such the Laplacian pyramid (r₁=L₁, r₂=UPSAMPLE (r₁)+L₂, L₃=UPSAMPLE (r₂)+L₃ . . . rₖ=UPSAMPLE (rₖ₋₁)+Lₖ). In one example, the final reconstruction of blended texture 222 can correspond to and/or be represented by rₖ. FIG. 9 illustrates an exemplary wrap operation 226 in which blended texture 222 are applied to and/or wrapped over head model 216. In some examples, wrap operation 226 can include and/or represent certain steps and/or features that serve purposes similar and/or identical to those described above in connection with any of FIGS. 1-8. As illustrated in FIG. 8, exemplary wrap operation 226 can include and/or involve wrapping and/or stretching blended texture 222 over and/or around head model 216 to generate and/or produce 3D avatar 230 of the user. Additionally or alternatively, exemplary wrap operation 226 can include and/or involve wrapping and/or stretching refined texture 608 over and/or around head model 216 to generate and/or produce 3D avatar 230 of the user.

In certain implementations, 3D avatar 230 can be animatable and/or controllable by the head and/or facial movements of the user (e.g., as captured by camera 106). For example, 3D avatar can follow the user's head and/or facial movements during the operation of a teleconferencing and/or VR application. Additionally or alternatively, 3D avatar 230 can include and/or show a substantially even distribution of illumination despite having been derived from images 202.

In some examples, the various devices and/or systems described in connection with FIGS. 1-9 can include and/or represent one or more additional circuits, components, and/or features that are not necessarily illustrated and/or labeled in FIGS. 1-9. For example, the devices, components, and systems in FIG. 1-9 can also include and/or represent additional analog and/or digital circuitry, onboard logic, transmitters, receivers, transceivers, transistors, resistors, capacitors, diodes, multiplexers, inductors, switches, registers, flipflops, connections, traces, buses, semiconductor (e.g., silicon) devices and/or structures, processing devices, storage devices, circuit boards, packages, substrates, housings, combinations or variations of one or more of the same, and/or any other suitable components that facilitate and/or support generating 3D avatars of users. In certain implementations, one or more of these additional circuits, components, devices, and/or features can be inserted and/or applied between any of the existing circuits, components, and/or devices illustrated in FIGS. 1-9 consistent with the aims and/or objectives provided herein. Accordingly, the electrical and/or communicative couplings described with reference to FIGS. 1-9 can be direct connections with no intermediate components, devices, and/or nodes or indirect connections with one or more intermediate components, devices, and/or nodes.

In some examples, the phrase “to couple” and/or the term “coupling,” as used herein, can refer to a direct connection and/or an indirect connection. For example, a direct coupling between two components can constitute and/or represent a coupling in which those two components are directly connected to each other by a single node that provides electrical continuity from one of those two components to the other. In other words, the direct coupling can exclude and/or omit any additional components between those two components.

Additionally or alternatively, an indirect coupling between two components can constitute and/or represent a coupling in which those two components are indirectly connected to each other by multiple nodes that fail to provide electrical continuity from one of those two components to the other. In other words, the indirect coupling can include and/or incorporate at least one additional component between those two components.

FIG. 10 is a flow diagram of an exemplary method 1000 for generating 3D avatars of users. In one example, the steps shown in FIG. 10 can be performed and/or executed during the operation of a computing device and/or pipeline. Additionally or alternatively, the steps shown in FIG. 10 can also incorporate and/or involve various sub-steps and/or variations consistent with the descriptions provided above in connection with FIGS. 1-9.

As illustrated in FIG. 10, exemplary method 1000 includes and/or involves the step of unwrapping a set of images that depict a head of a user into a set of 2D textures (1010). Step 1010 can be performed in a variety of ways, including any of those described above in connection with FIGS. 1-9. For example, a computing device can include and/or represent circuitry that unwraps a set of images that depict the head of a user into a set of 2D textures.

Exemplary method 1000 also includes and/or involves the step of generating a 3D avatar that depicts the user with even illumination by applying a blend of the 2D textures to a head model (1020). Step 1020 can be performed in a variety of ways, including any of those described above in connection with FIGS. 1-9. For example, the circuitry included in the computing device can generate a 3D avatar that depicts the user with even illumination by applying a blend of the 2D textures to a head model.

Exemplary method 1000 further includes the step of providing the 3D avatar for presentation by a display device (1030). Step 1030 can be performed in a variety of ways, including any of those described above in connection with FIGS. 1-9. For example, the circuitry included in the computing device can provide the 3D avatar for presentation by a display device. In one example, the display device can be incorporated into and/or coupled to the computing device. In another example, the display device can be incorporated into and/or coupled to a remote device in communication with the computing device.

While the foregoing disclosure sets forth various implementations using specific block diagrams, flowcharts, and examples, each block diagram component, flowchart step, operation, and/or component described and/or illustrated herein can be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality. Furthermore, the various steps, events, and/or features performed by such components should be considered exemplary in nature since many alternatives and/or variations can be implemented to achieve the same functionality within the scope of this disclosure.

The process parameters and sequence of the steps described and/or illustrated herein are given by way of example only and can be varied as desired. For example, while the steps illustrated and/or described herein are shown or discussed in a particular order, these steps do not necessarily need to be performed in the order illustrated or discussed. The various exemplary methods described and/or illustrated herein can also omit one or more of the steps described or illustrated herein or include additional steps in addition to those disclosed.

The preceding description has been provided to enable others skilled in the art to best utilize various aspects of the exemplary implementations disclosed herein. This exemplary description is not intended to be exhaustive or to be limited to any precise form disclosed. Many modifications and variations are possible without departing from the spirit and scope of the instant disclosure. The implementations disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computing device comprising:
circuitry configured to:
generate a set of two-dimensional textures based at least in part on a set of images that depict a head of a user; and
generate a three-dimensional avatar that depicts the head of the user with substantially even illumination by applying a blend of the set of two-dimensional textures to a head model; and
an output device configured to facilitate presentation of the three-dimensional avatar of the user.

2. The computing device of claim 1, wherein the circuitry is further configured to select the set of images for unwrapping into the set of two-dimensional textures due at least in part to the set of images depicting the head of the user from different viewing angles.

3. The computing device of claim 1, wherein the circuitry is further configured to shape the head model based at least in part on at least one of the set of images.

4. The computing device of claim 3, wherein the circuitry is further configured to:
render an estimate of the head model based at least in part on one or more input parameters;
compare the estimate of the head model to the at least one of the set of images; and
update the estimate of the head model by modifying the one or more input parameters based at least in part on a result of the comparison.

5. The computing device of claim 4, wherein the circuitry is further configured to:
compare the updated estimate of the head model to the at least one of the set of images according to a loss function; and
refine the updated estimate of the head model by modifying the one or more input parameters based at least in part on an output rendered by the loss function.

6. The computing device of claim 5, wherein the circuitry is further configured to iteratively compare the updated estimate of the head model to the at least one of the set of images and refine the updated estimate of the head model until the output rendered by the loss function satisfies a certain threshold.

7. The computing device of claim 1, wherein the circuitry is further configured to:
render the head model;
compare one or more facial features represented in the head model to one or more facial features identified in the at least one of the set of images; and
modify the facial features represented in the head model based at least in part on a result of the comparison.

8. The computing device of claim 1, wherein the circuitry is further configured to unwrap the set of images into the set of two-dimensional textures by flattening a depiction of a face of the user in the set of images to fit across a set of segmentation masks.

9. The computing device of claim 1, wherein the circuitry is further configured to generate the blend of the set of two-dimensional textures by:
sequentially blending portions of the set of two-dimensional textures; and
applying the sequentially blended portions of the set of two-dimensional textures to a template texture map.

10. The computing device of claim 9, wherein the circuitry is further configured to apply the sequentially blended portions of the set of two-dimensional textures to the template texture map using one or more Laplacian pyramids.

11. The computing device of claim 1, wherein the circuitry is further configured to mitigate, in the three-dimensional avatar, directional illumination depicted on the head of the user in the set of images.

12. The computing device of claim 1, wherein the circuitry is further configured to evenly illuminate facial features of the user in the three-dimensional avatar despite the facial features being unevenly illuminated in the set of images.

13. The computing device of claim 1, wherein the circuitry is further configured to refine the blend of the two-dimensional textures via a neural network architecture.

14. The computing device of claim 13, wherein the neural network architecture comprises at least one of:
a U-Net;
an artificial neural network; or
a convolutional neural network.

15. The computing device of claim 1, wherein the circuitry comprises a pipeline equipped with a plurality of data processing elements configured to generate the three-dimensional avatar from the set of images.

16. A system comprising:
a camera configured to capture a set of images that depict a head of a user; and
a computing device configured to:
generate a set of two-dimensional textures based at least in part on the set of images; and
generate a three-dimensional avatar that depicts the head of the user with even illumination by applying a blend of the set of two-dimensional textures to a head model.

17. The system of claim 16, wherein the camera comprises a webcam.

18. The system of claim 17, wherein the computing device comprises a laptop into which the webcam is integrated.

19. The system of claim 16, wherein the computing device is further configured to select the set of images for unwrapping into the set of two-dimensional textures due at least in part to the set of images depicting the head of the user from different viewing angles.

20. A method comprising:
generating, by circuitry of a computing device, a set of two-dimensional textures based at least in part on a set of images that depict a head of a user;
generating, by the circuitry, a three-dimensional avatar that depicts the head of the user with even illumination by applying a blend of the set of two-dimensional textures to a head model; and
providing the three-dimensional avatar for presentation by a display device.
